(19) United States
(12) Patent Application Publication
(10) Pub. No.: US 2024/0169285 A1
(43) Pub. Date: May 23, 2024

(54) CONTRIBUTION DEGREE ESTIMATION SYSTEM, CONTRIBUTION DEGREE ESTIMATION METHOD, AND PROGRAM

(71) Applicant: NEC Corporation, Tokyo (JP)

(72) Inventors: Satoshi ODA, Tokyo (JP); Takeshi Akagawa, Tokyo (JP); Hideki Komori, Tokyo (JP)

(73) Assignee: NEC Corporation, Tokyo (JP)

(21) Appl. No.: 18/389,343

(22) Filed: Nov. 14, 2023

(30) Foreign Application Priority Data
Nov. 21, 2022 (JP) 2022-186003

(51) Int. Cl. G06Q 10/0631

(52) U.S. Cl. CPC G06Q 10/063114

(57) ABSTRACT

A contribution degree estimation system includes: an information reception unit configured to receive project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project; an estimation unit configured to estimate the contribution degrees of the respective members using a trained model that has performed learning so as to receive, as input, the project information, the task information, and the member information and output contribution degrees of the respective members in the project; and a presenting unit configured to cause a display device to present the estimated contribution degrees of the respective member.

### INCORPORATION BY REFERENCE

This application is based upon and claims the benefit of priority from Japanese patent application No. 2022-186008, filed on Nov. 21, 2022, the disclosure of which is incorporated herein in its entirety by reference.

### TECHNICAL FIELD

The present disclosure relates to a contribution degree estimation system, a contribution degree estimation method, a program, and a learning apparatus.

### BACKGROUND ART

A project for accomplishing a predetermined goal involves a plurality of members with different skills. The determination and the evaluation of contribution degrees of the respective members in such a project are generally made by a client, a manager (e.g., a project manager) or the like. It is difficult, however, for the project manager to objectively and appropriately evaluate the contribution degrees of the respective members.

Japanese Unexamined Patent Application Publication No. 2021-184250 discloses a mechanism for achieving a relatively large-scale single project or relatively large-scale multiple projects with relatively less manpower and a mechanism for inputting and managing information for efficient use of resources. Further, Japanese Unexamined Patent Application Publication No. 2013-191077 discloses a skill evaluation apparatus that quantitatively and objectively evaluates, for a wide range of jobs, how much skill related to each task each person possesses.

However, none of Patent Literature is able to estimate contribution degrees of respective members with different skills participating in a project.

### SUMMARY

The present disclosure has been made in order to solve the aforementioned problem, and an object of the present disclosure is to provide a contribution degree estimation system and the like capable of estimating contribution degrees of respective members in a project involving a plurality of members with different skills.

A contribution degree estimation system according to one aspect of the present disclosure includes: an information reception unit configured to receive project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project; an estimation unit configured to estimate the contribution degrees of the respective members using a trained model that has performed learning so as to receive, as input, the project information, the task information, and the member information and output contribution degrees of the respective members in the project; and a presenting unit configured to cause a display device to present the estimated contribution degrees of the respective members.

A contribution degree estimation method according to one aspect of the present disclosure includes: receiving project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project; estimating the contribution degrees of the respective members using a trained model that has performed learning so as to receive, as input, the project information, the task information, and the member information and output contribution degrees of the respective members in the project; and causing a display device to present the estimated contribution degrees of the respective members.

A program according to one aspect of the present disclosure causes a computer to execute the following processing of: receiving project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project; estimating the contribution degrees of the respective members using a trained model that has performed learning so as to receive, as input, the project information, the task information, and the member information and output contribution degrees of the respective members in the project; and causing a display device to present the estimated contribution degrees of the respective members.

A learning apparatus according to one aspect of the present disclosure includes: a learning data acquisition unit configured to acquire learning data including a set of project information including at least one of a type, a goal, budget, or outcomes of a project, task information including at least one of levels of difficulties or market values of a plurality of required tasks that are required to carry out the project, member information including at least one of tasks, skills, roles, or knowledge of the respective members participating in the project, and contribution degrees of the respective members in the project; and a learning unit configured to generate a trained model that has performed learning so as to receive the learning data and output the contribution degrees of the respective members.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing an example of a contribution degree estimation system according to a first example embodiment;

FIG. 2 is a flowchart showing a contribution degree estimation method according to the first example embodiment;

FIG. 3 is a block diagram showing an example of a learning apparatus according to a second example embodiment;

FIG. 4 is a flowchart showing an example of a learning method according to the second example embodiment;

FIG. 5 is a diagram showing an example of a trained model and learning data according to the second example embodiment;

FIG. 6 is a block diagram showing an example of a contribution degree estimation system according to a third example embodiment;

FIG. 7 is a diagram for describing an example of input items according to the third example embodiment;

FIG. 8 is a diagram for describing an example of contribution degree presentation information according to the third example embodiment;

FIG. 9 is a block diagram of a contribution degree estimation system according to a fourth example embodiment; and

FIG. 10 is a block diagram showing a hardware configuration example of a contribution degree estimation apparatus and the like.

### EXAMPLE EMBODIMENT

### First Example Embodiment

Hereinafter, with reference to the drawings, this example embodiment will be described.

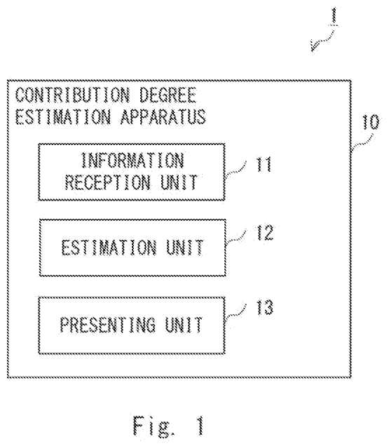

FIG. 1 is a block diagram of a contribution degree estimation system according to a first example embodiment.

A contribution degree estimation system 1 may be used to estimate contribution degrees of respective members with a variety of specialized skills participating in a project. The contribution degree estimation system 1 may also estimate expected contribution degrees of the respective members before the project is executed. The expected contribution degrees may be predicted values of degrees of contribution of the respective members to the project in the middle of the project or at the end of the project. Alternatively, the contribution degree estimation system 1 may estimate actual contribution degrees of the respective members after the project is completed. The expected contribution degrees that have been estimated may be used, for example, to manage the schedule of each member or predict and determine an amount of remuneration for each member. The project herein means a plan involving a plurality of members with different skills. Two or more members (e.g., two software engineers) having the same skills may participate in the project. The project may be managed by a project manager and the members having different skills may include, but not limited thereto, a software engineer, a hardware engineer, a researcher, an analyst, and a knowledge expert. Each of the members may work for one company or may not work for one company as he/she participates in the project as a freelancer.

The contribution degree estimation system 1 may include one or more contribution degree estimation apparatuses 10. The contribution degree estimation apparatus 10 may be implemented with one or more computers having one or more memories and one or more processors. As shown in FIG. 1, the contribution degree estimation apparatus 10 may include an information reception unit 11, an estimation unit 12, and a presenting unit 13. A control unit also serves as a function operation unit that executes each of segmented processes. Further, in some example embodiments, some of the components (or functions) may be executed by a computer other than the contribution degree estimation apparatus 10.

The information reception unit 11 receives, for example, project information, task information indicating a plurality of required tasks that are required to carry out a project, and member information indicating each of the members who participate in the project via an input interface. The required task used herein is a work unit that is required to complete the project.

The project information includes a project ID by which each project can be identified. Further, the project information may include one or all of a type, a goal, budget, and outcomes of the project. The project information may have a form of a Gantt chart including one or all of a type, a goal, budget, and outcomes of the project. The Gantt chart is a visual chart showing management of the progress status and the working plan of each task in the project management.

The type of the project includes, for example, but not limited to, consulting projects, business improvement projects, sales improvement projects, R&D projects, joint research projects, invention discovery projects, startup due diligence, overseas market research, end-user research, profit model design, design of kickbacks to agencies and the like of various industries. The goal indicates the direction and level of purposeful activities of an organization and individual (work behavior and outcome evaluation criteria). The outcomes, which are “things that should be done” required in view of the target or goal (including a personal goal as well), mean performance and results in a management practice process. In some example embodiments, the project information may include an achievement percentage for each required task. The achievement percentage for each required task may generally be 0% before the project is started and 100% after the project is completed.

The task information includes a task ID by which each task can be identified. Further, the task information may include at least one or both of levels of difficulties or market values of the plurality of required tasks that are required to carry out the project. The level of difficulty of each task may include, but not limited to, simple work, work to create added values, the level of the skill required to perform the work, and the possibility of substitution by a machine. The market value of the task may be determined based on an amount of remuneration of an outsourcing service of this task, remuneration in a job-changing market of those who can perform the task, this is merely an example, and it may be determined using various methods.

The member information includes a member ID by which each member can be identified and a terminal ID by which each user terminal used by each member can be identified. Further, the member information may include at least one or all of the tasks, skills, roles, knowledge, and experience of each member participating in the project. The skills of the member mean advanced capabilities developed through training and learning, and may include portable skills, literacy, and technical skills. Portable skills refer to “abilities that are portable” from one industry or occupation to another, and can be divided into task skills, self skills, and interpersonal skills. Literacy can refer to “foreign language, IT, and other techniques and abilities required across industries, sectors, and regions (cultures)”. More clearly, it can be expressed as “the ability to use the target object correctly. Technical skills can refer to specialized knowledge and techniques related to an industry, occupation, or region (culture), and can include, but are not limited to, communication skills, marketing techniques, product knowledge, programming skills, image editing skills, etc.

Further, the value of current skills can be determined from the current job offers (e.g., annual income by occupation, annual income by type of industry, or annual income by qualifications). Further, the expiration date of skills may be taken into account when the value of skills is determined. The expiration date of skills may be estimated from, for example, the transition from the past job offers to the current job offers. Further, the weight may be determined from a combination of industry and occupation.

The estimation unit 12 may include a trained model. The trained model may be the one that has performed machine learning so as to receive, as input, the project information, the task information, and the member information and output the contribution degrees of the respective members in the project. The trained model may be stored in a storage unit of the contribution degree estimation apparatus 10. In another example embodiment, the trained model may be stored in a storage unit outside the contribution degree estimation apparatus 10 connected via a network, and the estimation unit 12 may access this external storage unit to use this trained model. The contribution degrees may be values (amount of remuneration) given to the respective members in order to allocate the remuneration of the project. The trained model is a model that is constructed by learning a neural network using, as training data, the project information, the task information, the member information, and the values obtained by evaluating the contribution degrees of the respective members by an evaluator (a person or a team) for each type of the project. This learning method may also be called supervised learning. The trained model may be updated every time a predetermined amount of learning data is accumulated. In another example embodiment, another method using a neural network may be used.

The presenting unit 13 presents the estimated contribution degrees of the respective members. The presenting unit 13 may cause various kinds of display devices such as a display to display the contribution degrees of the respective members. The presenting unit 13 may transmit the contribution degrees to another device via a wired or wireless network and cause a display of the other device to present the contribution degrees. The presenting unit 13 may cause the display device to present the estimated contribution degrees of the respective members so that they can be compared with each other.

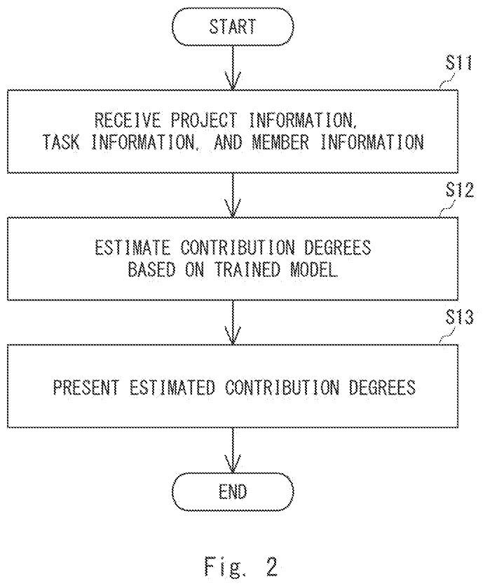

FIG. 2 is a flowchart showing a contribution degree estimation method.

The information reception unit 11 receives the project information, the task information, and the member information (Step S11). The estimation unit 12 estimates contribution degrees of respective members using a trained model (Step S12). The presenting unit 13 causes a display device to present the estimated contribution degrees of the respective members (Step S13).

According to the first example embodiment described above, it is possible to correctly and quickly estimate the contribution degrees of the respective members in a project involving a plurality of members with different skills before the project is started, in the middle of the project, or after the project is completed. Further, in some example embodiments, the contribution degrees may be estimated based on the results of each member's work in the middle of the project or after the project is completed. In this case, a degree of satisfaction of a client or the like with respect to the output provided by each member, a terminal operating time, the number of times of activities, a percentage of deadlines met or the like may be taken into account.

### Second Example Embodiment

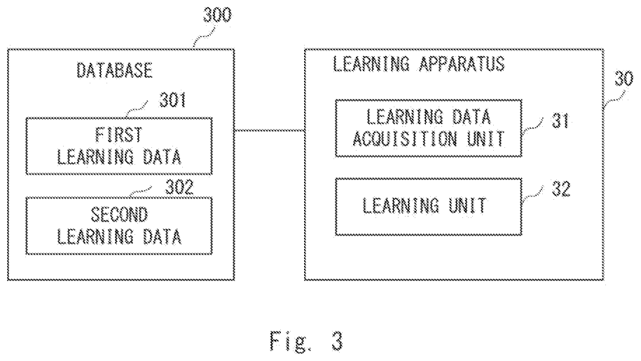

FIG. 3 is a block diagram showing an example of a learning apparatus.

A learning apparatus 30 may be used in the learning stage of machine learning. The learning apparatus 30 may be connected to a database 300 that stores learning data, the learning data including a set of project information, task information, member information, and contribution degrees of respective members in a project. This database 300 may be connected to a learning data acquisition unit 31 of the learning apparatus 30. The learning apparatus 30 may be implemented by one or more computers including a processor and a memory. The learning apparatus 30 includes a learning data acquisition unit 31 and a learning unit 32. The learning data of the database 300 may be updated periodically every time a predetermined amount of data is accumulated. Further, the learning data may be classified into a plurality of learning data items (e.g., a first learning data 301 and a second learning data 302). The learning data may be classified, for example, for each type of the project.

The learning data acquisition unit 31 receives, from the database 300, a set of information items including project information including at least one or all of a type, a goal, budget, or outcomes of a project, task information including at least one or all of levels of difficulties or market values of a plurality of required tasks that are required to carry out the project, member information including at least one or all of the task, skills, roles, or knowledge of each of the members who participate in the project, and contribution degrees of members in the project.

The learning unit 32 performs machine learning so as to receive learning data as input and output contribution degrees of the respective members in the project, thereby generating a trained model. Further, in some example embodiments, the learning unit 32 may generate different trained models (e.g., a first trained model and a second trained model) for different learning data items (e.g., the first learning data 301 and the second learning data 302). The trained models may be stored in a storage unit of the contribution degree estimation apparatus 10 or an external storage unit connected via a network. Further, in another example embodiment, each trained model for estimating the contribution degrees of the respective members before the project is started, in the middle of the project, or after the project is completed may be the one learned in view of the achievement percentage of each task.

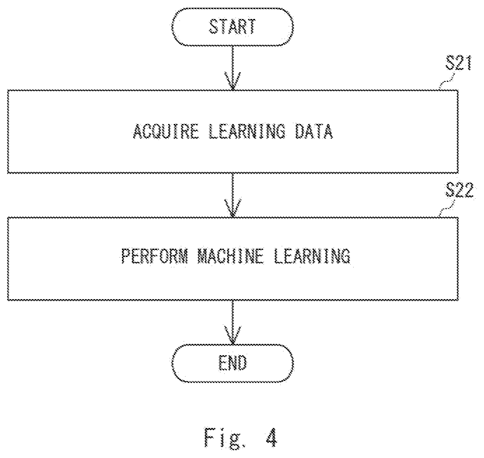

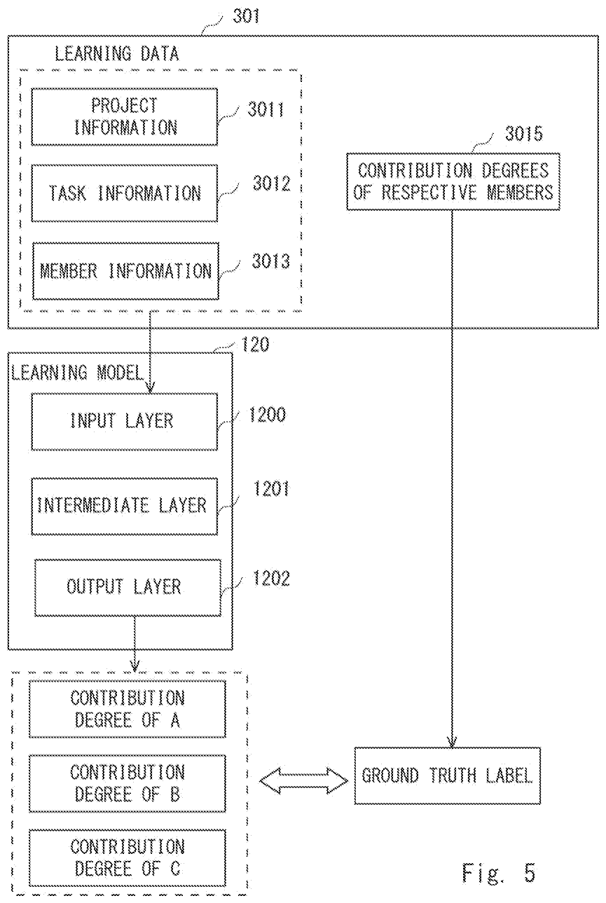

FIG. 4 is a flowchart showing a learning method. FIG. 5 is a diagram showing an example of the trained model and the learning data.

The learning data 301 used for machine learning of the learning model includes project information 3011, task information 3012, and member information 3013, and information regarding the contribution degrees of the respective members 3015.

The learning data acquisition unit 31 acquires a predetermined amount of learning data from the database 300 (Step S21). Next, the learning unit 32 performs machine learning using the learning data (Step S22). The learning model 120, which employs, for example, a structure of a neural network, includes an input layer 1200, an intermediate layer 1201, and an output layer 1202. There are synapses (not shown) connecting each neuron between layers, and weight parameters consisting of the weight of each synapse are adjusted by machine learning.

The input layer 1200 includes neurons that correspond to the project information 3011, the task information 3012, and the member information 3013 as input data, and the value of each piece of information is input to the corresponding neuron. The intermediate layer 1201 is formed of, for example, a plurality of layers. The output layer 1202 has neurons whose number correspond to the contribution degrees of the respective members as output data, and outputs results of inference of the contribution degrees of the respective members.

According to the learning apparatus described above, in a project involving a plurality of members with different skills, a trained model for estimating the contribution degrees of the respective members can be generated. Further, it is possible to generate different trained models for different industries or for different projects. Note that the example of the machine learning described above is merely an example and various modification examples may be employed.

### Third Example Embodiment

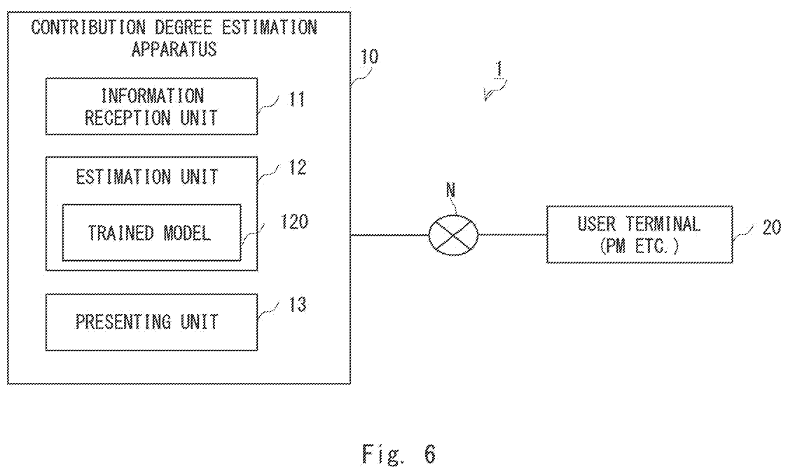

FIG. 6 is a block diagram showing an example of a contribution degree estimation system.

In a contribution degree estimation system 1 according to a third example embodiment, a project manager who manages a project can provide input information regarding a project that will be described later for a contribution degree estimation apparatus 10 using his/her user terminal 20, thereby obtaining contribution degrees of a plurality of respective members with different skills. Accordingly, the project manager can smoothly manage remuneration and progress of the project. The contribution degree estimation system 1 includes the contribution degree estimation apparatus 10 and the user terminal 20 connected to each other via a network N.

As described above, the contribution degree estimation apparatus 10 includes an information reception unit 11, an estimation unit 12, and a presenting unit 13. The user terminal 20 may be a computer device used by a user (e.g., project manager). The user terminal 20 may be any device such as a personal computer, a smartphone, or a wearable device.

The information reception unit 11 receives input information regarding a project from the user terminal 20. The estimation unit 12 estimates contribution degrees of the respective members using a trained model 120 based on the input information.

The presenting unit 13 is able to transmit data regarding the estimated contribution degrees to the user terminal 20 via a network and cause a display of the user terminal 20 to display the contribution degrees. The project manager can recognize, for example, the contribution degrees of the respective members via the user terminal 20 and appropriately manage the project.

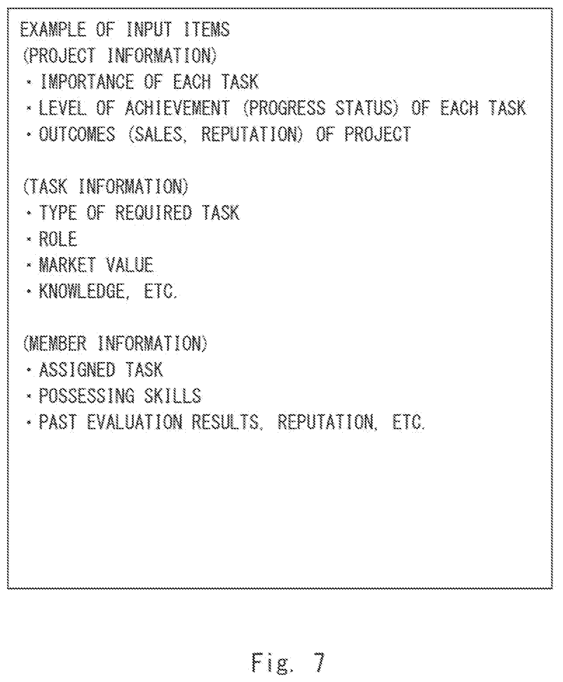

FIG. 7 shows an example of items input to the information reception unit 11.

The input items shown in FIG. 7 are input to the information reception unit 11 of the contribution degree estimation apparatus 10 by the project manager through the user terminal 20. The project manager selects a selection item on a predetermined user interface, whereby the project manager can enter the following information. The input items include, for example, project information, task information, and member information.

The project information further includes the importance of each task, the level of achievement (progress status) of each task, and outcomes (e.g., sales and/or reputation) of the project.

The task information includes the type of each required task, the role, the market value, knowledge and the like. The member information includes tasks, skills, past evaluation results, reputation and the like of each member.

After the aforementioned information items are input, the project manager can select an appropriate trained model. The project manager is able to select, for example, the trained model for each type of the project (e.g., consulting in specific industries).

In some example embodiments, the trained model is weighted for each required task in the project depending on the importance of the required task. Accordingly, the estimation unit 12 is able to estimate the contribution degrees of the respective members by associating the required tasks with the tasks assigned to the respective members.

In some example embodiments, the trained model is weighted, for example, for each piece of project information including at least one of a level of difficulty, the market value, or the importance of the required task. Accordingly, the estimation unit 12 is able to estimate different contribution degrees in accordance with the trained model for each piece of the project information.

In some example embodiments, the information reception unit 11 is able to receive project information including achievement percentages of the respective required tasks. The project manager enters the achievement percentages of the required tasks via his/her user terminal 20A, and this achievement percentages may be acquired by the information reception unit 11. Accordingly, the estimation unit 12 is able to estimate different contribution degrees for the different achievement percentages that have been received.

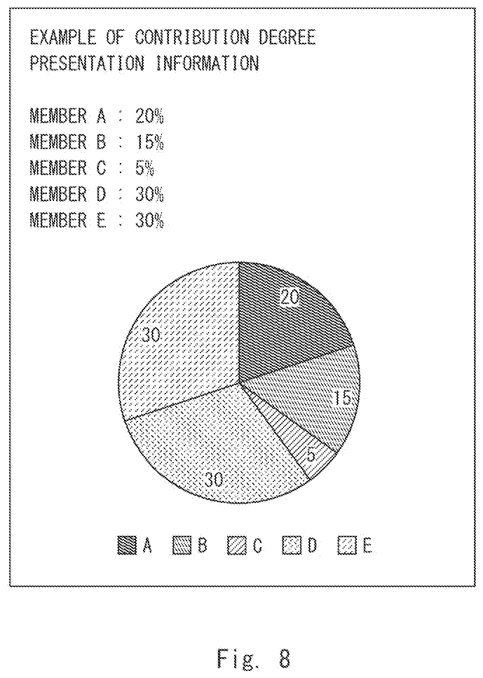

FIG. 8 is a diagram for describing an example of the contribution degree presentation information.

The contribution degree presentation information may indicate the contribution degrees of the respective members (A-E in FIG. 6) participating in the project. The contribution degrees may be indicated in various forms. The contribution degrees may be indicated, for example, by percentages of contributions of the respective members to the whole project or may be amounts of remuneration allocated to the respective members out of the total remuneration of the project. The method of presentation may be a form (e.g., a pie chart) in which it is possible to compare the contribution degrees.

### Fourth Example Embodiment

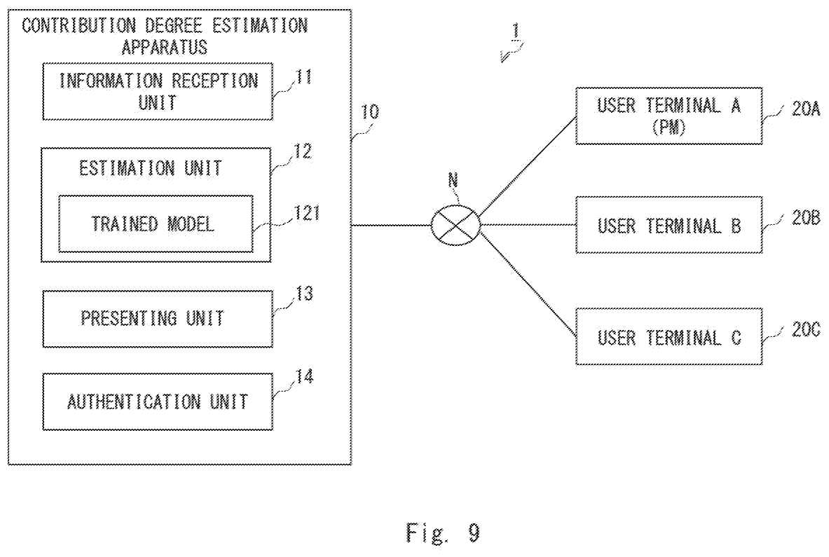

FIG. 9 is a block diagram of a contribution degree estimation system according to a fourth example embodiment.

A contribution degree estimation system 1 according to this example embodiment includes a contribution degree estimation apparatus 10 and a plurality of user terminals 20A-20C that are connected to one another via a network N. The plurality of user terminals may be used by users having different levels of authority. In this example, for example, the user terminal 20A may be used by a project manager. The user terminals 20B and 20C may be used by persons participating in the project with skills different from each other. In this example embodiment, the user terminals 20B and 20C may be used in a Decentralized Autonomous Organization (DAO) as well. In the DAO, in general, governance tokens may be distributed to people such as a developer, an affiliated partner, and a user who are participating in the DAO depending on the degrees of contribution to the DAO.

Unlike the processing in the third example embodiment, an authentication unit 14 for authenticating a user terminal is added to the contribution degree estimation apparatus 10 according to this example embodiment. Note that the components other than the authentication unit 14 are basically the same.

The authentication unit 14 authenticates user terminals of members participating in the project. The authentication unit 14 is able to authenticate the user terminals of the respective members by using, for example, a desired authentication method such as a user ID or a password. The authentication unit 14 can authenticate user terminals at different authentication levels of the user terminals in accordance with the authority levels given to the members. For example, as described above, the user terminal 20A may be authenticated at the authority level of the project manager. On the other hand, the user terminals 20B and 20C may be authenticated at an authority level of a person participating in the project.

The presenting unit 13 can cause the user terminal 20B authenticated by the authentication unit 14 to present, for example, only the contribution degree of the member B in the whole project. Further, the presenting unit 13 may cause the user terminal 20C authenticated by the authentication unit 14 to present, for example, only the contribution degree of the member C in the whole project. On the other hand, the presenting unit 13 may cause the user terminal 20A that has been authenticated by the authentication unit 14 and is used by the project manager to present the contribution degrees of the respective members (e.g., B and C). Accordingly, the project manager is able to know the contribution degrees of the respective members and manage the schedule or the load of the project. Further, each of the members is able to know only his/her contribution degree in the whole project.

As described above, since the contribution degree estimation apparatus 10 includes the authentication unit 14, it is possible to present separate contribution degrees in different forms depending on the authentication level (i.e., at the authority level of the owner of the user terminal).

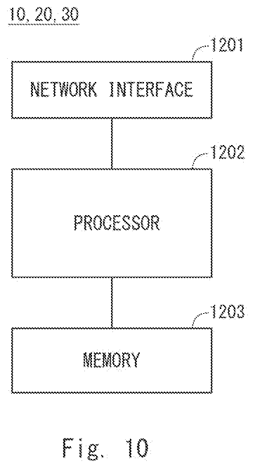

FIG. 10 is a block diagram showing a hardware configuration example of the contribution degree estimation apparatus 10, the user terminal 20, the learning apparatus 30 and the like (hereinafter, the contribution degree estimation apparatus 10 and the like).

Referring to FIG. 10, the contribution degree estimation apparatus 10 and the like include a network interface 1201, a processor 1202, and a memory 1203. The network interface 1201 is used to communicate with another network node apparatus that constitutes a communication system. The network interface 1201 may be used to perform wireless communication. For example, the network interface 1201 may be used to perform wireless LAN communication defined by the IEEE 802.11 series, or a mobile communication defined by the 3rd Generation Partnership Project (3GPP) (registered trademark). Alternatively, the network interface 1201 may include, for example, a network interface card (NIC) in compliance with the IEEE 802.3 series.

The processor 1202 loads software (a computer program) from the memory 1203 and executes this loaded software, thereby performing processing of the contribution degree estimation apparatus 10 and the like described with reference to the flowchart or the sequence in the above-described example embodiments. The processor 1202 may be, for example, a microprocessor, a Micro Processing Unit (MPU), GPU (Graphics Processing Unit) or a Central Processing Unit (CPU). The processor 1202 may include a plurality of processors.

The memory 1203 is composed of a combination of a volatile memory and a non-volatile memory. The memory 1203 may include a storage located apart from the processor 1202. In this case, the processor 1202 may access the memory 1203 via an I/O interface (not shown).

In the example shown in FIG. 10, the memory 1203 is used to store software modules. The processor 1202 loads these software modules from the memory 1203 and executes these loaded software modules, thereby performing processing of the contribution degree estimation apparatus 10 and the like described in the aforementioned example embodiments.

As described with reference to FIG. 2 or 4, each of the processors included in the contribution degree estimation apparatus 10 and the like executes one or more programs including instructions for causing a computer to execute the algorithm described with reference to the drawings.

In the aforementioned examples, the program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments and may be changed as appropriate without departing from the scope of the present disclosure. The first to fourth embodiments can be optionally combined as desirable by one of ordinary skill in the art.

The whole or part of the example embodiments disclosed above can be described as, but not limited to, the following supplementary notes.

### (Supplementary Note 1)

A contribution degree estimation system comprising:
an information reception unit configured to receive project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project;
an estimation unit configured to estimate the contribution degrees of the respective members using a trained model that has performed learning so as to receive, as input, the project information, the task information, and the member information and output contribution degrees of the respective members in the project; and
a presenting unit configured to cause a display device to present the estimated contribution degrees of the respective members.

### (Supplementary Note 2)

The contribution degree estimation system according to Supplementary Note 1, wherein
the trained model is weighted for each of the required tasks in the project, and
the estimation unit estimates the contribution degrees of the respective members by associating the required tasks with the tasks assigned to the respective members.

### (Supplementary Note 3)

The contribution degree estimation system according to Supplementary Note 1, wherein
the trained model is weighted for each piece of the project information including at least one of a level of difficulty, a market value, and importance of the required task, and
the estimation unit estimates different contribution degrees in accordance with the trained model for each piece of the project information.

### (Supplementary Note 4)

The contribution degree estimation system according to Supplementary Note 1, wherein
the information reception unit receives the project information including achievement percentages of the respective required tasks, and
the estimation unit estimates different contribution degrees for the different achievement percentages.

### (Supplementary Note 5)

The contribution degree estimation system according to Supplementary Note 1, wherein the estimation unit selects one of a plurality of trained models that are stored and estimates the contribution degrees.

### (Supplementary Note 6)

The contribution degree estimation system according to Supplementary Note 1, further comprising an authentication unit configured to authenticate user terminals used by the plurality of respective members,
wherein the information reception unit receives the member information from each of the user terminals that have been authenticated.

### (Supplementary Note 7)

The contribution degree estimation system according to Supplementary Note 1, wherein the estimation unit outputs reasons for estimating the respective contribution degrees.

### (Supplementary Note 8)

The contribution degree estimation system according to Supplementary Note 1, further comprising an authentication unit configured to authenticate user terminals used by the plurality of respective members,
wherein the presenting unit causes a display device to present the contribution degrees in different aspects depending on an authentication level via the authenticated user terminal.

### (Supplementary Note 9)

A contribution degree estimation method comprising:
receiving project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project;
estimating the contribution degrees of the respective members using a trained model that has performed learning so as to receive, as input, the project information, the task information, and the member information and output
contribution degrees of the respective members in the project; and presenting the estimated contribution degrees of the respective members.

### (Supplementary Note 10)

A program for causing a computer to execute the processing of:
receiving project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project;
estimating the contribution degrees of the respective members using a trained model that has performed learning so as to receive, as input, the project information, the task information, and the member information and output contribution degrees of the respective members in the project; and
presenting the estimated contribution degrees of the respective members.

### (Supplementary Note 11)

A learning apparatus comprising:
a learning data acquisition unit configured to acquire learning data including a set of
   project information including at least one of a type, a goal, budget, or outcomes of a project, task information including at least one of levels of difficulties or market values of a plurality of required tasks that are required to carry out the project, member information including at least one of tasks, skills, roles, or knowledge of the respective members participating in the project, and contribution degrees of the respective members in the project; and
a learning unit configured to generate a trained model that has performed learning so as to receive the learning data and output the contribution degrees of the respective members.

According to the present disclosure, it is possible to estimate contribution degrees of respective members in a project involving a plurality of members with different skills.

What is claimed is:

1. A contribution degree estimation system comprising:
at least one memory storing instructions, and
at least one processor configured to execute the instructions to;
receive project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project;
estimate the contribution degrees of the respective members using a trained model that has performed learning so as to receive, as input, the project information, the task information, and the member information and output contribution degrees of the respective members in the project; and
cause a display device to present the estimated contribution degrees of the respective members.

2. The contribution degree estimation system according to claim 1, wherein
the trained model is weighted for each of the required tasks in the project, and
the at least one processor configured to execute the instructions to estimate the contribution degrees of the respective members by associating the required tasks with the tasks assigned to the respective members.

3. The contribution degree estimation system according to claim 1, wherein
the trained model is weighted for each piece of the project information including at least one of a level of difficulty, a market value, and importance of the required task, and
the at least one processor configured to execute the instructions to estimate different contribution degrees in accordance with the trained model for each piece of the project information.

4. The contribution degree estimation system according to claim 1, wherein
the at least one processor configured to execute the instructions to receive the project information including achievement percentages of the respective required tasks, and
estimate different contribution degrees for the different achievement percentages.

5. The contribution degree estimation system according to claim 1, wherein the at least one processor configured to execute the instructions to select one of a plurality of trained models that are stored and estimates the contribution degrees.

6. The contribution degree estimation system according to claim 1, wherein the at least one processor configured to execute the instructions to authenticate user terminals used by the plurality of respective members,
receive the member information from each of the user terminals that have been authenticated.

7. The contribution degree estimation system according to claim 1, wherein the at least one processor configured to execute the instructions to output reasons for estimating the respective contribution degrees.

8. The contribution degree estimation system according to claim 1, wherein the at least one processor configured to execute the instructions to authenticate user terminals used by the plurality of respective members,
cause a display device to present the contribution degrees in different aspects depending on an authentication level via the authenticated user terminal.

9. A contribution degree estimation method comprising:
receiving project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project;
estimating the contribution degrees of the respective members using a trained model that has performed learning so as to receive, as input, the project information, the task information, and the member information and output contribution degrees of the respective members in the project; and
presenting the estimated contribution degrees of the respective members.

10. A non-transitory computer readable medium storing a program for causing a computer to execute the following processing of:
receiving project information including at least one of a type, a goal, budget, or outcomes of a project, task information including at least one of levels of difficulties or market values of a plurality of required tasks that are required to carry out the project, and member information including at least one of tasks, skills, roles, or knowledge of the respective members participating in the project;
estimating the contribution degrees of the respective members using a trained model that has performed learning so as to receive, as input, the project information, the task information, and the member information and output contribution degrees of the respective members in the project; and
presenting the estimated contribution degrees of the respective members.
